(19) United States
(12) Patent Application Publication
(10) Pub. No.: US 2014/0019194 A1
(43) Pub. Date: Jan. 16, 2014

(54) Predictive Key Risk Indicator Identification Process Using Quantitative Methods

(71) Applicant: Ajay Kumar Anne, Peoria, IL (US)

(72) Inventor: Ajay Kumar Anne, Peoria, IL (US)

(73) Assignee: Bank of America, Charlotte, NC (US)

(21) Appl. No.: 13/547,853

(22) Filed: Jul. 12, 2012

(51) Int. Cl. G06Q 10/00

(52) U.S. Cl. 705/7.28

(57) ABSTRACT

Methods, computer-readable media, and apparatuses are disclosed for identifying predictive key risk indicators (KRIs) for organizations and/or firms through the application of specific statistical and quantitative methods that are well integrated with qualitative adjustment. An indicator is a variable with the purpose of measuring change in a phenomena or process. A risk indicator is an indicator that estimates the potential for some form of resource degradation using mathematical formulas or models. Organization/enterprise key risk indicators are an essential arsenal in the risk management framework of any firm or organization and may be required by regulatory agencies.

### FIELD

Aspects of the embodiments relate to a computer system that provides methods and/or instructions for identifying predictive key risk indicators (KRIs) for organizations and/or firms through the application of specific statistical and quantitative methods that are well integrated with qualitative adjustment.

### BACKGROUND

Risk management is a process that allows any associate within or outside of a technology and operations domain to balance the operational and economic costs of protective measures while protecting the operations environment that supports the mission of an organization. Risk is the net negative impact of the exercise of vulnerability, considering both the probability and the impact of occurrence.

An organization typically has a mission. Risk management plays an important role in protecting against an organization's operational risk losses or failures. An effective risk management process is an important component of any operational program. The principal goal of an organization's risk management process should be to protect against operational losses and failures, and ultimately the organization and its ability to perform the mission.

One method of risk management utilizes enterprise key risk indicators (KRIs). KRIs are an essential arsenal in the risk management framework of any firm, organization, or corporation. KRIs may be required by outside regulatory agencies for given industries. For example, in the financial industry, KRIs are required by the Basel Capital Accord for AMA compliance. Most firms or organizations apply qualitative and judgmental methods to narrow down a known/given set of potential risk indicators, before arriving at a core set of agreed upon KRIs. “Predictive KRIs” are the most sought after and most wished for, but no sound and proven methodology currently existed to identify enterprise level predictive KRIs (as evidenced through literature surveys, industry benchmarking, and conversations with US financial regulatory agencies). Current risk management external processes and methods vary from 1) risk indicators cannot predict operational risk losses or failures on one extreme to 2) identifying a large number of available indicators and labeling a number of them as predictive even if there is nothing predictive of losses in the methodology to identify “predictive” indicators.

### BRIEF SUMMARY

Aspects of the embodiments address one or more of the issues mentioned above by disclosing methods, computer readable media, and apparatuses that provide instructions or steps for identifying predictive key risk indicators (KRIs) for organizations and/or firms through the application of specific statistical and quantitative methods that are well integrated with qualitative adjustment.

According to an aspect of the invention, a computer-assisted method provides identification of predictive key risk indicators (KRIs) for organizations and/or firms through the application of specific statistical and quantitative methods that are well integrated with qualitative adjustment. The method may include the steps of: 1) identifying a set of key risks using a first triangulation process with risk information for an identified risk; 2) identifying risk indicators associated with the identified risks using a second triangulation process; 3) conducting, by a risk management computer system, quantitative and statistical analysis to identify a set of statistical associations and a set of predictive relationships of the risk indicators and the key risks through correlation testing and regression modeling; and 4) selecting a set of predictive key risk indicators from the set of statistical associations and the set of predictive relationships. Additionally, the method may also include the step of monitoring the set of key risk indicators for performance. Additionally, the method may also include the steps of: setting thresholds for the set of predictive key risk indicators; and verifying coverage for the set of predictive key risk indicators. Further, the method may include the step of reporting potential gaps in coverage for the set of predictive key risk indicators. The method may also include the step of pre-processing risk data to perform the quantitative and statistical analysis. This pre-processing risk data step may also include: processing, by the risk management computer system, of risk data by building metric risk data sets; performing, by the risk management computer system, data analysis of the metric risk data sets; and profiling, by the risk management computer system, the metric risk data sets to enable the quantitative and statistical analysis. The pre-preprocessing of risk data step may include a Box-Cox power transformation or a set of time-series plots. Further, the regression modeling includes metric association with loss frequency and metric association with loss severity. Additionally, during the selecting a set of predictive key risk indicators step, a prioritization scheme may be applied that includes the following four components: quantitative aspects, qualitative feedback, exposure to multiple business units, and historical loss exposure.

According to another aspect of the invention, the first triangulation process may include risk information for the identified risk that includes: historical losses, emerging risks, and qualitative judgment. A historical loss heat map may be utilized to identify and report historical losses in two dimensions (one by business unit and other by risk event type). The choice of historical time-frame may be five year or more or less. Additionally, the second triangulation process includes: obtaining monitoring metrics for each of the identified risks, using qualitative judgment to validate and narrow down the monitoring metrics that serve as candidate key risk indicators, and performing selective causal analysis and hypothesis testing.

According to another aspect of the invention, an apparatus may include at least one memory; and at least one processor coupled to the at least one memory and configured to perform, based on instructions stored in the at least one memory. The instructions might include the steps of: identifying a set of key risks using a first triangulation process with risk information for an identified risk; identifying risk indicators associated with the identified risks using a second triangulation process; pre-processing risk data to perform the quantitative and statistical analysis; conducting, by a risk management computer system, quantitative and statistical analysis to identify a set of statistical associations and a set of predictive relationships of the risk indicators and the key risks through correlation testing and regression modeling; selecting a set of predictive key risk indicators from the set of statistical associations and the set of predictive relationships; setting thresholds for the set of predictive key risk indicators; and verifying coverage for the set of predictive key risk indicators. The at least one processor may be further configured to perform reporting potential gaps in coverage for the set of predictive key risk indicators. The pre-processing risk data instruction may further include: processing, by the risk management computer system, of risk data by building metric risk data sets; performing, by the risk management computer system, data analysis of the metric risk data sets; and profiling, by the risk management computer system, the metric risk data sets to enable the quantitative and statistical analysis. Furthermore, the pre-preprocessing of risk data instruction may include a Box-Cox power transformation or a set of time-series plots. Additionally, the first triangulation process includes risk information for the identified risk that includes: historical losses, emerging risks, and qualitative judgment, and further wherein the historical losses are identified by a historical loss heat map. Further, the second triangulation process may include: obtaining monitoring metrics for each of the identified risks, using qualitative judgment to validate and narrow down the monitoring metrics and validate and narrow down the risk indicators, and performing selective causal analysis and hypothesis testing.

Aspects of the embodiments may be provided in a computer-readable medium having computer-executable instructions to perform one or more of the process steps described herein.

These and other aspects of the embodiments are discussed in greater detail throughout this disclosure, including the accompanying drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative operating environment in which various aspects of the invention may be implemented.

FIG. 2 is an illustrative block diagram of workstations and servers that may be used to implement the processes and functions of certain aspects of the present invention.

FIG. 3 shows a flow chart for identifying predictive key risk indicators in accordance with an aspect of the invention.

FIGS. 4 through 10 show various illustrative tables for use with example embodiments in accordance with aspects of the invention.

### DETAILED DESCRIPTION

In accordance with various aspects of the invention, methods, computer-readable media, and apparatuses are disclosed for identifying predictive key risk indicators (KRIs) for organizations and/or firms through the application of specific statistical and quantitative methods that are well integrated with qualitative adjustment. An indicator is a variable with the purpose of measuring change in a phenomena or process. A risk indicator is an indicator that estimates the potential for some form of resource degradation using mathematical formulas or models.

With embodiments of the invention, a risk management tool identifies organization/enterprise predictive key risk indicators through the application of specific statistical and quantitative methods that are well integrated with qualitative adjustment. Organization/enterprise key risk indicators are an essential arsenal in the risk management framework of any firm or organization and may be required by regulatory agencies. For example, United States regulatory (inter-agency) guidance on the advanced measurement approaches for operational risk in June 2011 stated: “BEICFs [Business Environment & Internal Control Factors] are indicators of a bank's operational-risk profile that reflect a current and forward-looking assessment of the bank's underlying business-risk factors and internal control environment. BEICFs are forward-looking tools that complement the other elements in the AMA framework. Common BEICF tools include risk and control self-assessments, key risk indicators, and audit evaluations.” (emphasis added).

Most traditional firms or organizations apply qualitative and judgmental method to narrow down a known/given set of potential risk indicators, before arriving at a core set of agreed key risk indicators. No sound or proven methodology exists to identify enterprise level predictive key risk indicators. Current external work, processes, and methods vary from 1) risk indicators cannot predict operational risk losses or failures on one extreme (as referenced by Alvarez and Gledhill in “How to take control” as published by OperationalRiskandRegulation.com 24 Nov. 2010) to 2) identifying a large number of available indicators and labeling some of them as predictive even if there is nothing predictive of losses in the methodology to identify “predictive” KRIs (as referenced by Immaneni in “A structured approach to building predictive key risk indicators” published in The RMA Journal May 2004). Alvarez and Gledhill state that KRIs are “a byproduct of the RCSA (Risk and Control Self-assessment) process” and further saying that “risk indicators cannot predict operational risk losses or failures.”

On the other hand, Immaneni has a decent framework to identify and monitor KRIs, but falls short of reaching predictive indicators. Step 1 of Immaneni, identify existing metrics, is subjective and qualitative based on a business/subject matter expert opinion. In contrast, with aspects of the present invention incorporates quantitative aspects and a triangulation process by incorporating historical loss exposures of businesses. Additionally, in aspects of the present invention, available indicators are not used at the start, but start with the question of “what are the key/top risks” and what indicators monitors those key/top risks. The remaining steps (2 and 3) of Immaneni employ a subjective scoring method (assigning a score of 1, 3, or 9) to factors such as data availability and data source accuracy. In contrast, aspects of the present invention utilize robust statistical methods such as multivariate regression to identify critical explanatory variables, rank correlation of the candidate metrics against realized losses to determine associations, and analyze in depth by incorporating lag-lead aspects, body vs. tail and other similar methods of analysis. Fundamentally, the data availability and data source accuracy methods do not make critical determinants of the right KRIs, but instead once the right KRIs are identified, data accuracy programs should be incorporated to ensure the KRI (metric) data is accurate.

How do you identify “key risks” especially when the exposure landscape is constantly shifting? Historical experience (loss event based such as risks translated into actual loss events), emerging risks, risk and control self-assessments, business/subject matter expert judgment, voice of the customer, scenario workshops, stress testing, and external losses all may help to identify key risks.

What kind of relation between risks and indicators is to be expected in social/behavior sciences? Is it 1-1, 1-n, n-1, n-n? It turns out that for complex phenomena, such as operational risk, typically it is n-n. That means a given key risk can be monitored by one or more indicators, and likewise a given key risk indicator can monitor one or more key risks simultaneously.

How do you identify and “tie” an indicator to a risk? Generally, there is agreement that the indicator should “associate” risk with some “confidence.” However, there may be a diverse range of industry definition with “association” and “confidence.” In aspects of this invention, a “reasonable certainty” test may be applied. “Reasonable certainty” is distinguished from “absolute (or mathematical) certainty.” Generally, the loss of profits must be the natural and proximate, or direct, result of the breach complained of and they must also be capable of ascertainment with reasonable, or sufficient, certainty, or there must be some basis on which a reasonable estimate of the amount of the profit can be made; absolute certainty is not called for or required. In aspects of the present invention, some basis may be provided by Granger Causality (statistical association) blended with human interpretation, as will be described later.

In identifying “predictive” KRIs, a diverse range of observed practice may occur in the industry. Specifically, in the financial industry, the Basel Framework, range of practice, regulatory expectations, and industry research may all be utilized. These all may show a lack of clarity and convergence of thought and practices. Although not mandated by the Basel regulatory framework, predictive indicators are the most sought for to be utilized for risk management. Predictive indicators may be predictive of future losses and may give executive management the opportunity to review current/existing controls and determine an action plan to remediate gaps in the controls.

There are many typical CTQs (Critical to Quality measures) and defining characteristics of a good predictive risk indicator. Validity—does the risk indicator provide a causal relation with the phenomena of interest? Cost-effectiveness—is there a right balance between the reliability and the efforts needed to obtain the data? Accuracy—is the variable or indicator measurable in a sufficient and precise way? Sensitivity—is the variable or indicator reacting quickly and clearly enough?

There are many other factors that make the operational risk management process a complex problem and difficult to solve. One factor may be the dynamic nature of the risk environment. Even well-designed and effective KRIs can diminish in value as organizational objectives and strategies adapt to an ever-changing business, economic, legislative and regulatory environment. Another factor may be the dynamic nature of the control environment. Even in an ideal situation in which the correct risks, controls, and indicators are thought to be identified and monitored, still business divisions and/or business units can and will address control deficiencies, and in effect prevent translation of control weakness to realized loss events, affecting forecasts and back-testing results. Another factor may be the risk culture, organizational maturity, and executive management active support. Most organizations are data heavy, but information sparse. Additionally, business goals may conflict with the risk culture/appetite. Another factor may be the organizational alignment and organizational dynamics. Furthermore, a factor may be sampling data challenges such as data quality issues. Observational data as opposed to experimental data may limit the experimentation that can be done to prove the validity of the indicator. Additionally, sparse data (such as highly unbalanced panel data, with “sampling zeros” as opposed to “structural zeros”) may not leave much room for test data. It is well known that regression models constructed in small data sets provide overconfident predictions, (i.e., higher prediction will be found too high, and low predictions will be found too low).

According to an aspect of the invention, identifying predictive key risk indicators may include one or more of the following steps: 1) identify key risks using a triangulation process using available information; 2) identify candidate risk indicators (explanatory variables) using a triangulation process; 3) processing of data by building metric data sets, performing exploratory data analysis, and profiling and data transformations; 4) conducting quantitative and statistical analysis to identify statistical associations and predictive relationships through correlation testing and regression modeling; 5) selecting predictive KRI from top candidate metrics; 6) setting thresholds and verifying indicator coverage of top risks and reporting potential gaps.

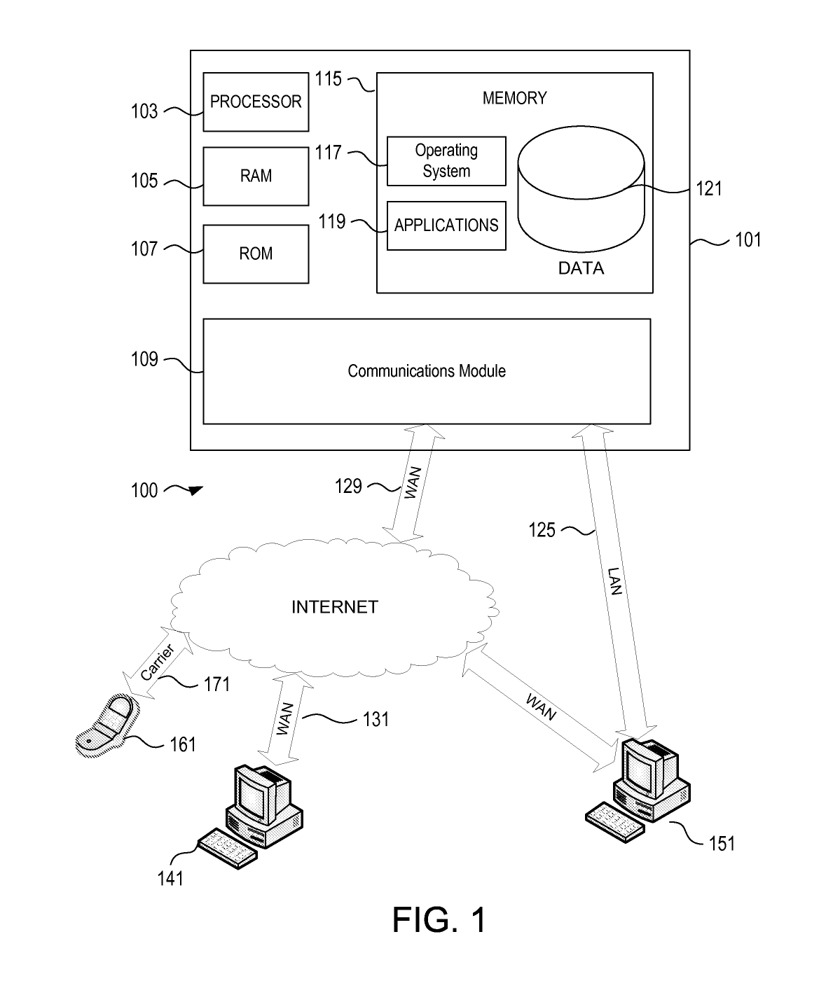

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality of the invention. The computing system environment 100 should not be interpreted as having any dependency or requirement relating to any one or combination of components shown in the illustrative computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including RAM 105, ROM 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts, to digital files.

Although not shown, RAM 105 may include one or more are applications representing the application data stored in RAM memory 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of the computer executable instructions for computing device 101 may be embodied in hardware or firmware (not shown). Database 121 may provide centralized storage of risk information including attributes about identified risks, characteristics about different risk frameworks, and controls for reducing risk levels that may be received from different points in system 100, e.g., computers 141 and 151 or from communication devices, e.g., communication device 161.

Computing device 101 may operate in a networked environment supporting connections to one or more remote computing devices, such as branch terminals 141 and 151. The branch computing devices 141 and 151 may be personal computing devices or servers that include many or all of the elements described above relative to the computing device 101. Branch computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 is connected to the LAN 825 through a network interface or adapter in the communications module 109. When used in a WAN networking environment, the server 101 may include a modem in the communications module 109 or other means for establishing communications over the WAN 129, such as the Internet 131. It will be appreciated that the network connections shown are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages. The network connections may also provide connectivity to a CCTV or image/iris capturing device.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the invention may include forms of computer-readable media. Computer-readable media include any available media that can be accessed by a computing device 101. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the invention is contemplated. For example, aspects of the method steps disclosed herein may be executed on a processor on a computing device 101. Such a processor may execute computer-executable instructions stored on a computer-readable medium.

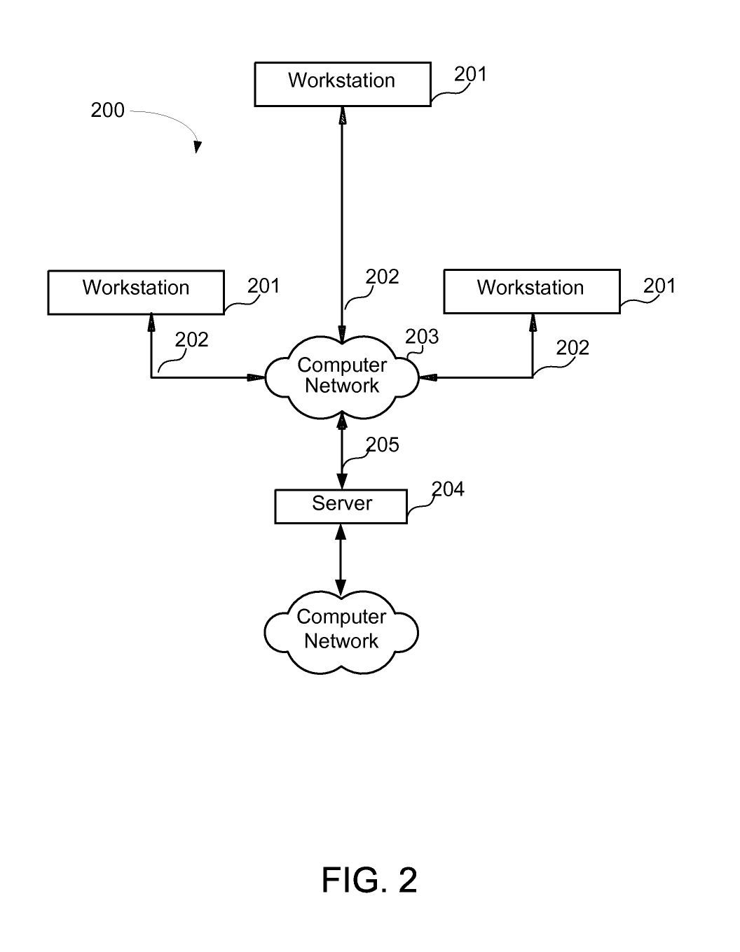

Referring to FIG. 2, an illustrative system 200 for implementing methods according to the present invention is shown. The system 200 may be a risk management system in accordance with aspects of this invention. As illustrated, system 200 may include one or more workstations 201. Workstations 201 may be local or remote, and are connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links. Connectivity may also be supported to a CCTV or image/iris capturing device.

The steps that follow in the figures may be implemented by one or more of the components in FIGS. 1 and 2 and/or other components, including other computing devices.

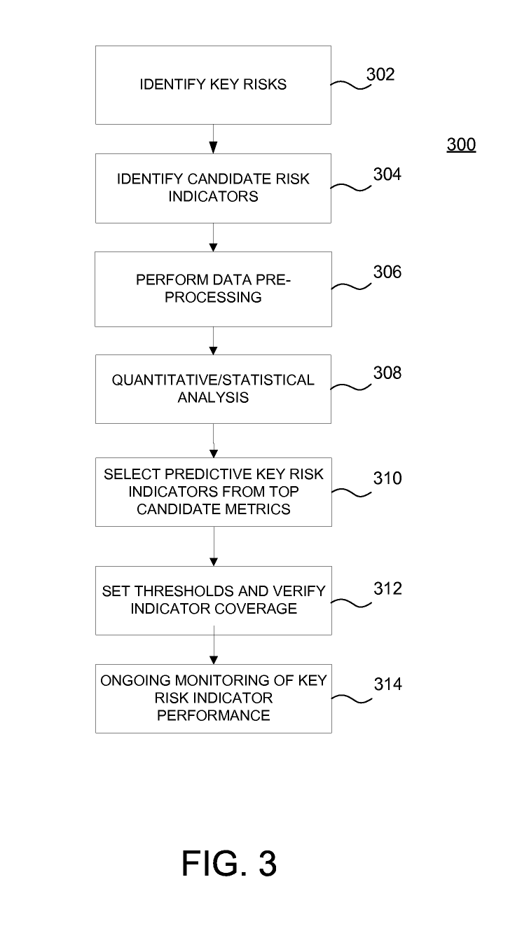

FIG. 3 shows a flow chart 300 for identifying predictive key risk indicators (KRIs) through the application of specific statistical and quantitative methods that are well integrated with qualitative adjustment in accordance with an aspect of the invention. There may be many different outputs associated with aspects and embodiments of this invention, which may include, but are not limited to: identified organizational/enterprise predictive key risk indicators (KRIs) and regression models that help in loss forecasting (which is a by-product of the KRI identification process). Additionally, many outside agencies/organizations, such as regulators, have identified this invention as cutting-edge and industry leading.

As illustrated in FIG. 3, the method may include one or more of the following steps: 1) identify key risks using a triangulation process using available information 302; 2) identify candidate risk indicators using a triangulation process 304; 3) processing of data by building metric data sets, performing exploratory data analysis, and profiling and data transformations 306; 4) conducting quantitative and statistical analysis to identify statistical associations and predictive relationships through correlation testing and regression modeling 308; 5) selecting predictive KRI from top candidate metrics 310; 6) setting thresholds and verifying indicator coverage of top risks and reporting potential gaps 312. One additional step may be monitoring of KRI performance 314.

At block 302, key risks are identified using a triangulation process using one or more of three pieces of information. The three pieces of information may include but are not limited to: historical losses, emerging risks, and qualitative judgment. A triangulation process (also termed as cross-validation) may be the process of combining data/information/methods from different sources to arrive at a specific point of knowledge by manner of convergence. (Refer to: http://www.unaids.org/en/media/unaids/contentassets/documents/document/2010/10_{—}4-Intro-to-triangulation-MEF.pdf).

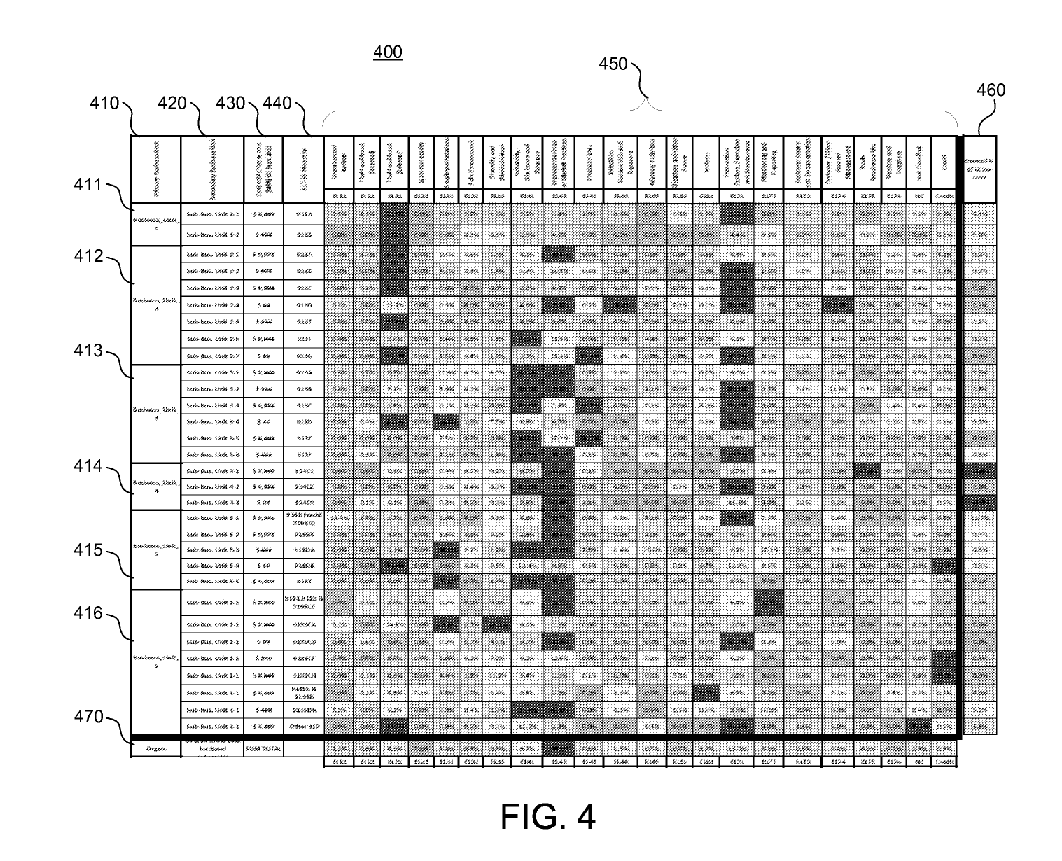

Historical losses may help define granular units-of-measure (UOMs) and identify historical risks. As illustrated in FIG. 4, a historical loss heat-map 400 may be utilized to define the granular UOMs and identify historical risks. The heat-map 400 may be unique to every firm or organization. A historical loss heat map may be utilized to identify and report historical losses in two dimensions (one by business unit and other by risk event type). The historical loss heat-map 400 may include a variety of different columns and rows. Generally, the columns along the left side of the historical loss heat-map 400 represent business units with exposure to operational losses. Generally, the rows along the top side of the historical loss heat-map 400 represent operational risk event types. The percentage numbers in the middle of the historical loss heat-map 400 represent operational loss expressed as a percentage, with higher numbers representing a higher risk and the lower numbers representing a lower risk. The historical loss heat-map 400 may include a column for primary business units 410. In addition to the primary business units 410, each primary business unit 410 may have a list of secondary business units 420.

Additionally, another column may be the gross loss 430 (in millions of dollars) for each secondary business unit 420. Another column in the heat-loss map 400 may include the “ALT-91” hierarchy 440 (a Basel category rating) for each secondary business unit 420. Furthermore, the ending columns list the percentage loss in each of the various Basel categories 450 for each secondary business unit 420. Colors may be utilized to illustrate various breakdowns of percentage losses. In the final column is listed the percentage of the total loss 460 across each secondary business unit 420. In the final row of the heat-loss map 400 is a percentage loss total 470 across each Basel category 450.

A heat map structure may be utilized to identify and report historical operational losses and present the information in two dimensions (one by business units and other by risk event type). Risk event types may be internal fraud, external fraud, employment practices and workplace safety, clients, products and business practices, damage to physical assets, business disruption and systems failure, and execution, delivery and process management risks. The choice of historical time-frame may be five year or more or less. The “heat” illustrates the severity of exposure of a given business unit to a specific kind of risk relative to other business units and/or other risk event types. Similar heat-map can be constructed to show-case operational loss event volume (frequency) as opposes to loss amount (severity), since they complement each other.

Emerging risks may validate and adjust units-of-measure through core risk management programs. Core risk management programs may include but not be limited to: emerging risks, scenario analysis, and risk and control self-assessment (RCSA) process. Generally, self-assessment programs, such as RCSAs, may identify the state of key risks and controls. High residual risks may be good candidates for key risks. Additionally, high inherent risks may be next in line for good candidates for key risks to be identified. In an organization, typically inherent risks and residual risks are categorized into High, Medium and Low.

Lastly, as part of step 302 and identifying key risks, qualitative judgment may be used. Qualitative judgment may include business judgment or voice and/or risk judgment or voice. Qualitative judgment may be incorporated to confirm the top risks, validate those risks, and if necessary adjust the top risks. Firms or organizations may utilize a root-cause analysis of historical loss information to assist with the qualitative judgment.

As illustrated in FIG. 3, at block 304, the next step is identifying candidate risk indicators. Candidate risk indicators may also be referred to as explanatory variables. Candidate risk indicators may be identified using a triangulation process by identifying candidate monitoring metrics and mapping those risk indicators to specific units-of-measure.

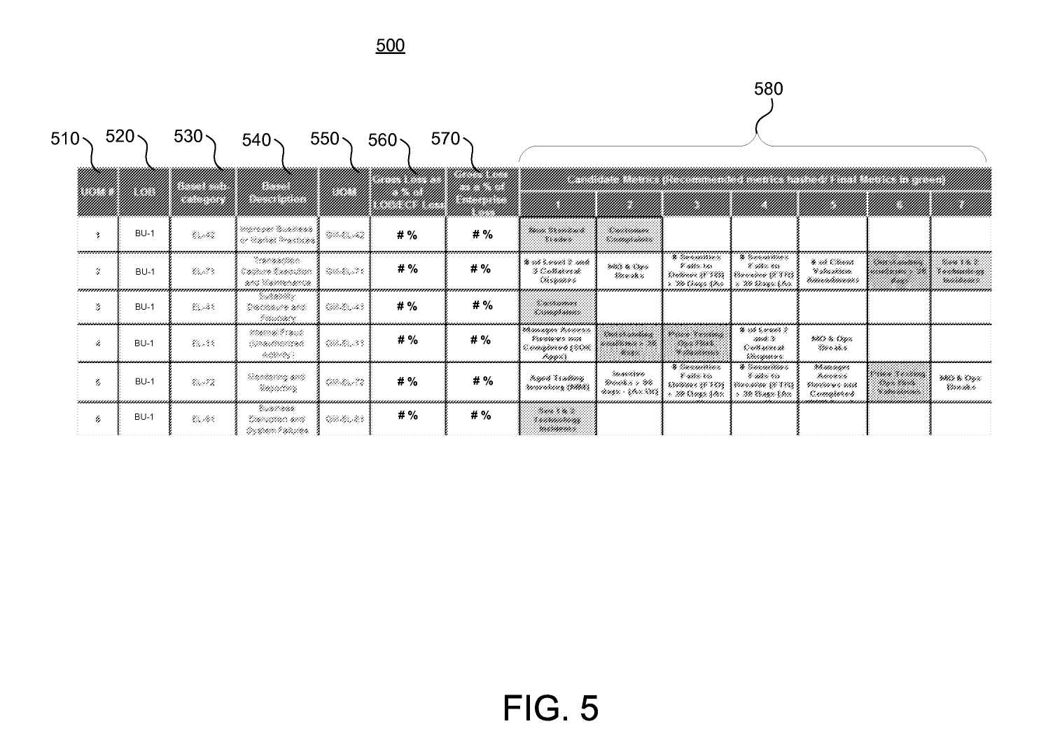

First, for each of the top risks and units-of-measure, monitoring metrics may be obtained for the specific risks identified above (for example, self assessed high residual risks). These top risks are typically captured within the RCSAs and other compliance/risk monitoring programs. FIG. 5 illustrates an example table 500 that may be utilized for this step. On the table, along the left side are listed each of the unit-of-measures (UOMs) 510. With each UOM 510 is listed the business units 520 associated with that UOM, the Basel sub-category number 530, the Basel description 540, the UOM number 550, the gross loss as a percentage of the business unit loss 560, and the gross loss as a percentage of organization/enterprise loss 570. Other categories may be listed and associated with the UOM without departing from this disclosure.

Lastly, the table 500 as illustrated in FIG. 5 may also include candidate metrics associated with each UOM 580. For example, for UOM 1, “Improper Business or Market Practices,” the candidate metrics may include but not be limited to: non-standard trades, and customer complaints. In another example, for UOM 2, “Transaction Capture Execution and Maintenance,” the candidate metrics may include but not be limited to: number of level 2 and 3 collateral disputes, office and operations breaks, number of securities fails to deliver (FTD) greater than 30 days, number of securities fails to receive (FTR) greater than 30 days, number of client valuation amendments, outstanding confirms greater than 30 days, severity 1 and 2 technology incidents.

The second component of the triangulation process in the identify candidate risk indicators 304, may be the use of business and risk voice or qualitative judgment being incorporated. The business and qualitative judgment may be incorporated to validate and if necessary narrow down metrics for statistical analysis. Additionally, the business and qualitative judgment may be incorporated to validate and if necessary adjust the mapping of the candidate risk indicators to top risks as illustrated in FIG. 5.

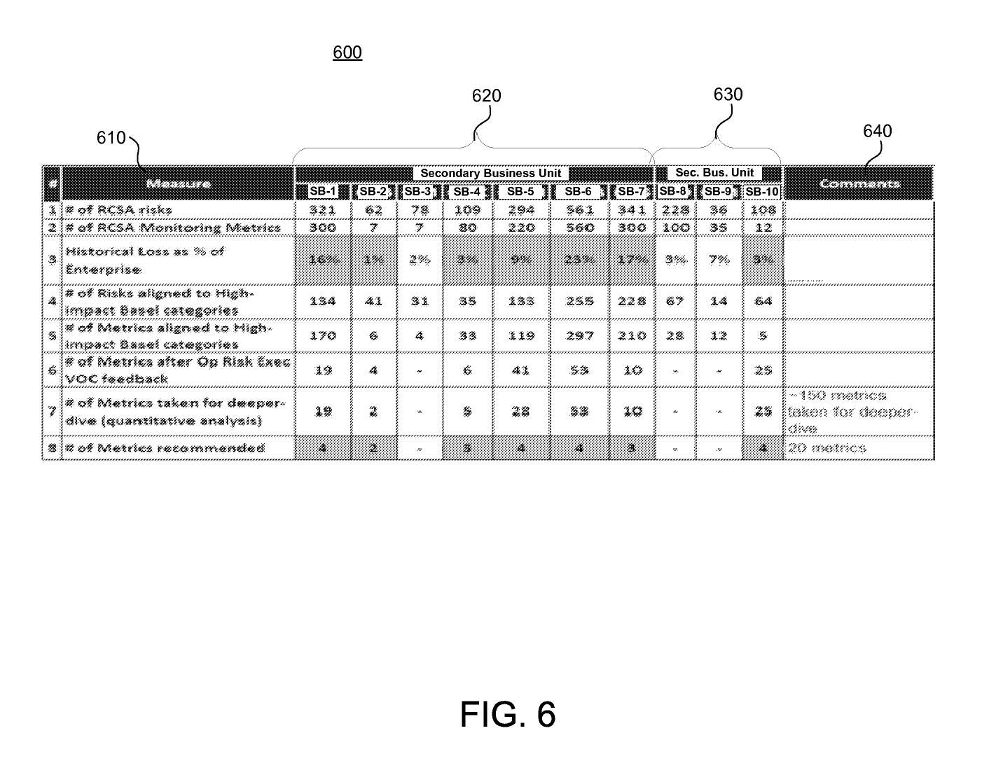

FIG. 6 illustrates an exemplary table 600 for incorporating business and qualitative judgment. FIG. 6 lists eight different measurements or metrics 610 along the vertical axis that may be utilized to compare and analyze the various business units 630. The eight measures 610 listed for this exemplary embodiment are: 1) number of RCSA risks; 2) number of RCSA monitoring metrics; 3) historical loss as a percentage of enterprise; 4) number of risks aligned to high-impact Basel categories; 5) number of metrics aligned to high-impact Basel categories; 6) number of metrics after operation risk executive VOC feedback; 7) number of metrics taken for deeper-dive (quantitative analysis); and 8) number of metrics recommended. Additional measures 610 may be utilized without departing from this invention.

Along the horizontal axis, FIG. 6 lists various business units and secondary business units 630 (labeled as SB-1, SB-2, and so on) with their respective values for each of the measures listed. FIG. 6 may also include a column for “Comments” 640 for each of the various measures. For example, for the number of metrics taken for deeper dive measurement, the comment may be listed as “150 metrics taken for deeper-dive.” In another example, for the number of metrics recommended, the comment may be listed as “20 metrics.”

The third component of the triangulation process in the identify candidate risk indicators 304, may be the selective causal analysis and hypothesis testing being performed to validate the mapping. This causal analysis may be selectively blended with the above measurements illustrated in FIG. 6 as fact/data-based inputs. Generally, causal questions require some knowledge of the data generating process and cannot be computed from the data alone, nor from the distributions that govern the data. Statistics may deal with behavior under uncertain, yet statistical conditions, while causal analysis may deal with changing conditions. For example, for causality, there may be three necessary conditions: 1) statistical associations, 2) appropriate time order, and 3) elimination of alternative hypotheses or establishment of formal causal mechanism. Additionally, generally no mathematical analysis can fully verify whether a given causal graph such as a DAG (directed acyclic graph) represents true causal mechanisms that generate the data. This verification may be left better either to human judgment or to experimental studies that invoke interventions.

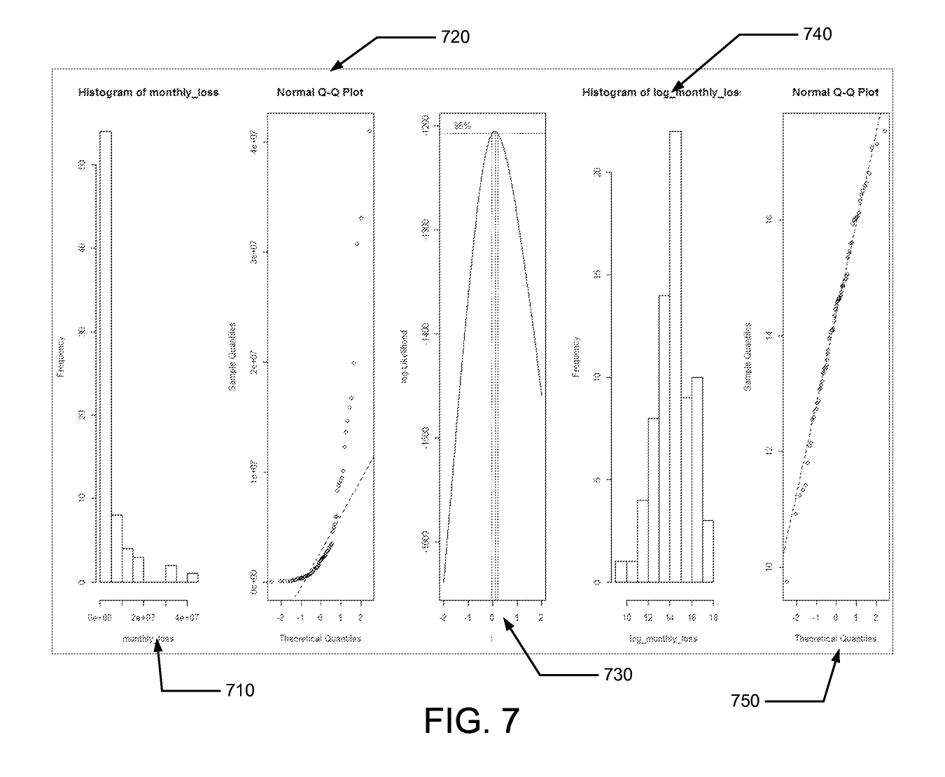

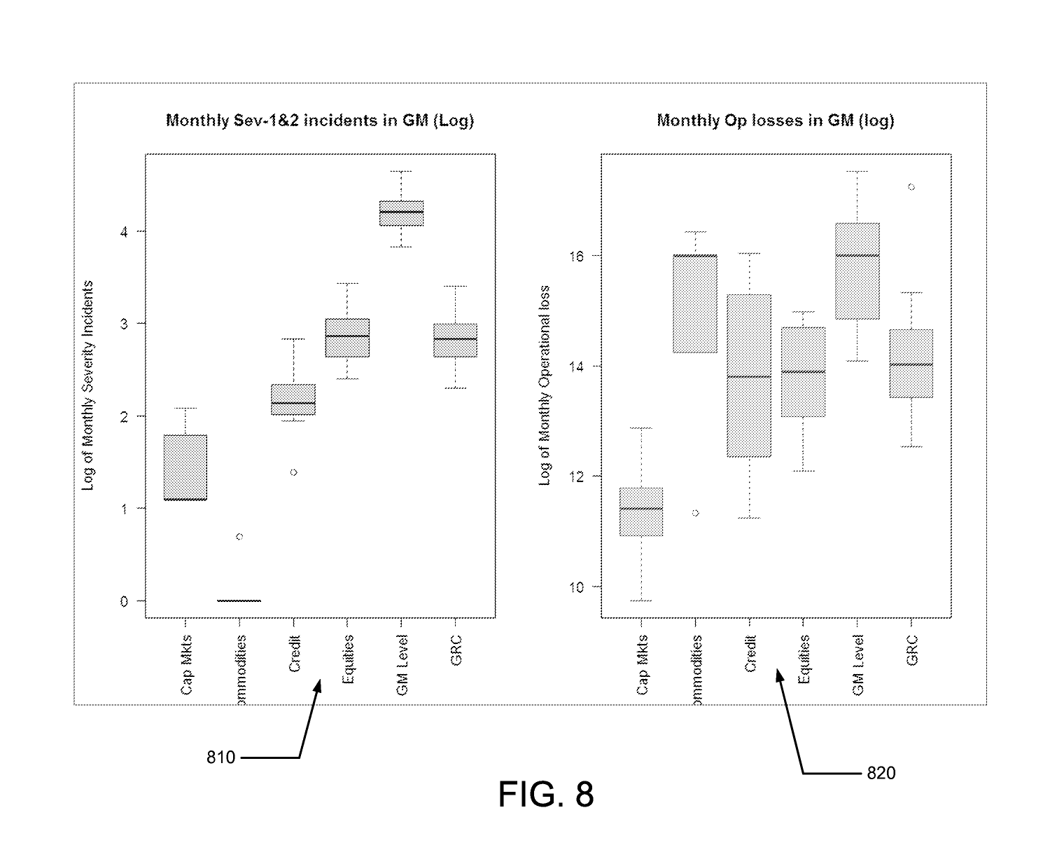

As illustrated in FIG. 3, at block 306, the next step is data pre-processing. The data-pre-processing step 306 may include building metric data sets, performing exploratory data analysis, and/or profiling and data transformations. The data preprocessing step 306 may also include building metric and loss data sets, most likely at granular levels. Additionally, this may include incorporating predictive aspect by comparing current metrics with 3-month losses. This may include current and subsequent 2-months of data. Other time frames may be utilized for this comparison without departing from this invention. Additionally, during the data pre-processing step 306, a check for data sample normality, stationarity, and other essential characteristics before statistical analysis may be performed. Generally, a Box-Cox power transformation may be applied wherever applicable. Additionally, time-series plots and subject-matter experts input may be utilized to understand trends and lag information. Some example plots are illustrated in FIG. 7. The table identified by 710 is a histogram of monthly losses. The table identified by 720 is a normal Q-Q plot. The table identified by 730 is a Log-likelihood plot depicting the value at which log-likelihood is maximized. In this specific illustration identified by 730, lambda (X) is near zero indicating the appropriateness of logarithmic transformation of the response variable (operational loss). The table identified by 740 is a histogram of monthly losses after logarithmic transformation of the data. The table identified by 750 is a normal Q-Q plot of the same loss data after logarithmic transformation. FIG. 8 illustrates two exploratory data plots, for example plot 810 illustrates Box-and-whiskers plot of the explanatory variable (e.g., severity incidents in Global Markets in logarithmic scale across various units within the line of business) and plot 820 illustrates Box-and-Whiskers plot of the response variable (e.g., monthly operational losses of Global Markets line of business in logarithmic scale). Furthermore, other exploratory data analysis may be utilized in the data pre-processing step 306.

As illustrated in FIG. 3, at block 308, the fourth step may be quantitative/statistical analysis. The quantitative/statistical analysis 308 may be utilized to identify statistical associations and predictive relationships through the use, for example, of correlation testing and regression modeling.

In the quantitative/statistical analysis step 308, variable selection and regression modeling may be performed. Numerous iterations may be utilized in order to find the best fit of the data. Additionally, automated variable selection methods may be utilized. During this analysis, a number of items may be checked and verified, such as: serial correlation of errors, the impact of leverage points in the data, fitting diagnostics, and/or multi-collinearity. Throughout this process, the functional specification will be validated and tested as appropriate. Under correlations methods, a rank correlation may be preferred over linear correlation.

Additionally, regression modeling may be performed separately for loss frequency and severity data. Granger causality analysis may be one preferred method to be used for testing. In the Granger causality analysis, if the historical loss can be better predicted with the usage of a key risk indicator (KRI) explanatory variable in addition to lagged loss as opposed to just using lagged loss, generally, risk drivers (or KRIs as a proxy for risk drivers) Granger Cause losses. For example, “A variable X Granger-causes Y, if Y can be better predicted using the histories of both X and Y than it can be using the history of Y alone.” Variable Y may then be substituted with operational loss and variable X with a KRI (candidate metric). “Granger causation” does not prove certain and solid causation, but in may be better than a correlation of two variable X and Y.

Additionally, in this quantitative/statistical analysis step 308, metric association with loss frequency may be performed. For metric association with loss frequency, count regression models may be used for frequency. Normally, Poisson frequency models may be simpler one-parameter models. However, due to special characteristics exhibited by the loss data (such as mean NE variance, presence of overdispersion, zero preponderance), negative binomial models may be better in this exemplary embodiment than the Poisson frequency models. Additionally, zero inflated negative binomial model and hurdle models may also be applicable in this situation to determine predictive KRIs with operational loss as a response variable in predictive modeling.

Additionally, in the quantitative/statistical analysis step 308, metric association with loss severity may be performed. For the loss severity model, ordinary least-squares (OLS) after logarithmic transformed or quantile regression may be utilized. For example, in a situation when the explanatory variables are more than the sample observation cases, penalized regression models (such as least angle regression models) should be used.

Furthermore, in the quantitative/statistical analysis step 308, various estimates may be performed, such as: measures of dependence (rank correlations), statistical significance, confidence intervals, observed vs. expected direction of correlation. Supplementing statistical analysis with causal analytics may be utilized as appropriate. For example, systems failure metrics may be compared with systems losses and also transactional losses. Transactional losses may include losses stemming from a failed transaction due to a system outage.

The quantitative/statistical analysis step 308 may also include out-of-sample testing. Due to possible data sparseness (resulting from highly unbalanced panel datasets), it may not be possible to apply the 50-25-25 rule for training-testing-validation as recommended by some authorities. Therefore, to perform out-of-sample testing, a leave-one-out cross-validation (LOOCV) may be selectively applied by computing the predicted residual sum of squares (PRESS) statistic. Furthermore, the KRI regression models that may be an output of the quantitative/statistical analysis step 308 may also be used for loss forecasting, in addition to determining KRIs.

As further illustrated in FIG. 3, at block 310, the fifth step may be predictive KRI selection from top candidate metrics. The predictive KRI selection from top candidate metrics step 310 may allow an application of a judicious balance between the statistical findings and the subject-matter expert experiential judgment.

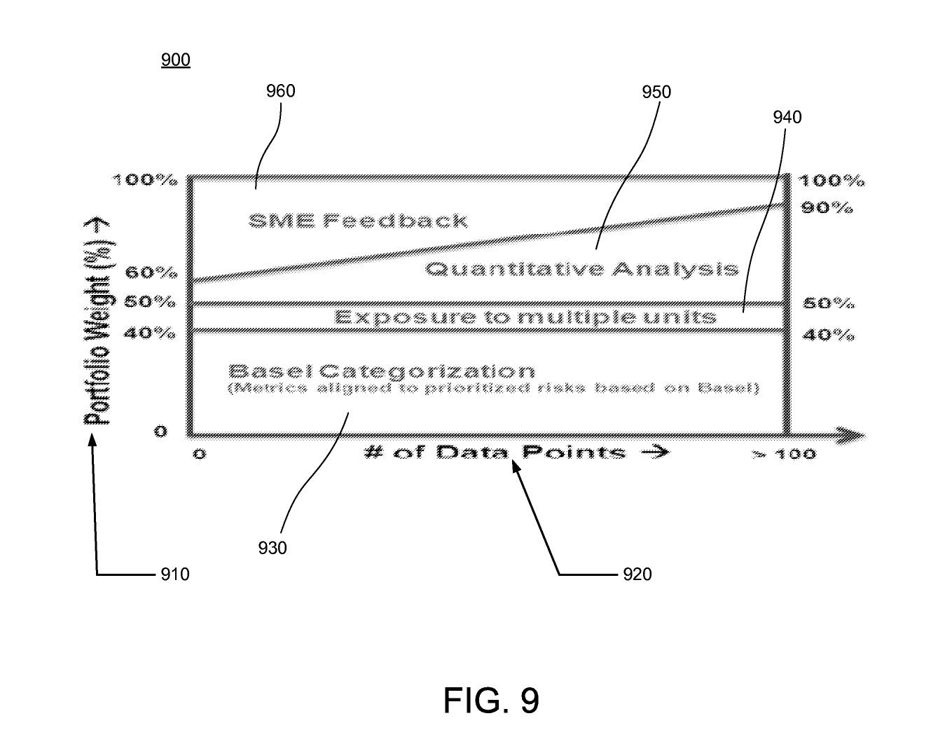

For the selecting predictive KRI from top candidate metrics step 310, if required, a prioritization scheme may be utilized as illustrated in FIG. 9. As illustrated in FIG. 9, the prioritization scheme may include the following four components: 1) historical loss exposure, such as high-impact Basel categories 930; 2) exposure to multiple business units of the organization 940; 3) quantitative aspects 950; and 4) qualitative subject-matter expert feedback 960. The advantage of using the prioritization scheme as detailed below is that wherever the sample size is extremely small, qualitative may override quantitative. Likewise, on the other hand with good sample sizes, quantitative results may have higher weights. As illustrated in FIG. 9, based on the number of data points 920 along the horizontal axis, determines the portfolio weight percentages 910 as illustrated on the vertical axis. For example, with minimal data points 920, the quantitative analysis portion 950 of the portfolio weight percentage 910 is low. And conversely, with the maximum amount of data points 920, the quantitative analysis portion 950 of the portfolio weight percentage 910 is high. Following the prioritization scheme as illustrated in FIG. 9, the results may be reviewed and analyzed with business unit risk before finalizing the KRIs.

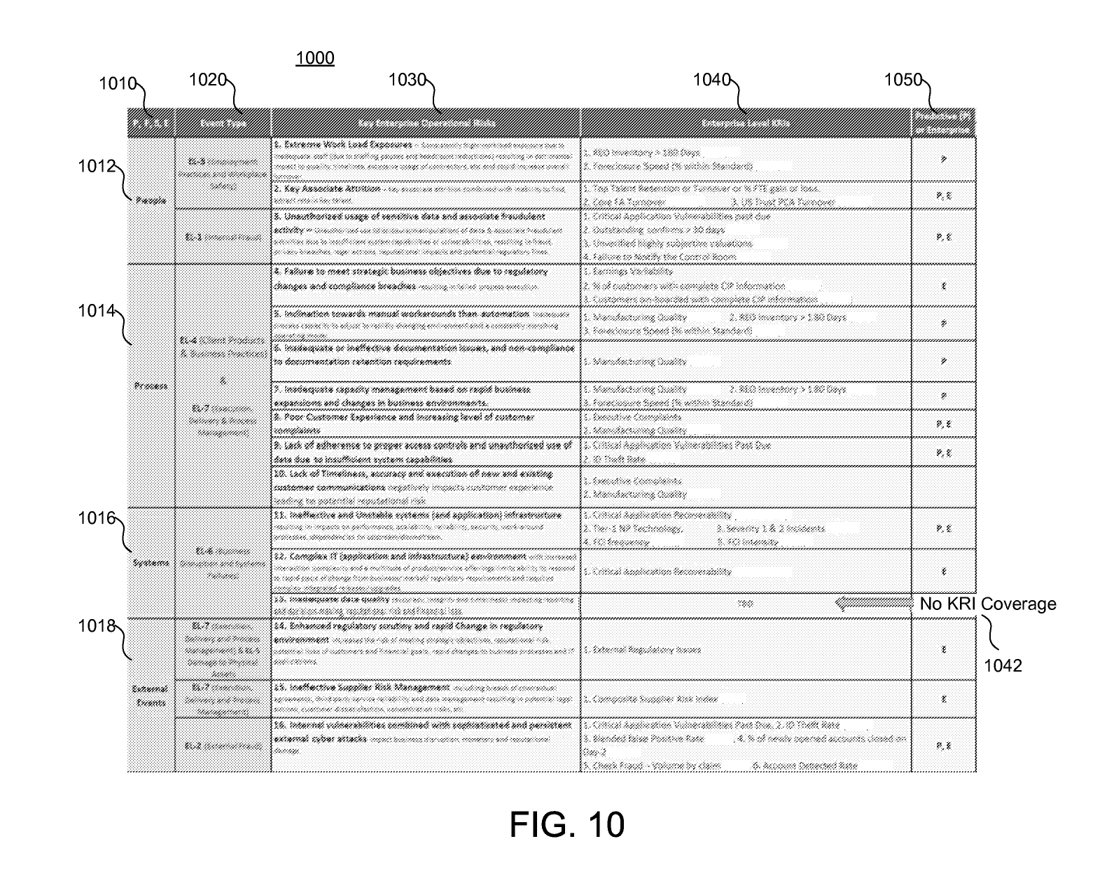

As illustrated in FIG. 3, at block 312, the sixth step may be to set thresholds and verify indicator coverage of top risks, and then report gaps. In this step 312, thresholds are set, both as limits and triggers, based on the risk requirements of the organization and a balance of the risk and reward of the organization. Additionally, during this step 312, indicators coverage of the top risks is verified. An example of this verification is illustrated below in FIG. 10.

FIG. 10 illustrates a number of key enterprise/organization operational risks 1030. An example list of key enterprise/organization operational risks 1030 may include, but not be limited to: 1) extreme work load exposures; 2) key associate attrition; 3) unauthorized usage of sensitive data and associate fraudulent activity; 4) failure to meet strategic business objectives due to regulatory changes and compliance breaches; 5) inclination towards manual workaround than automation; inadequate or ineffective documentation issues, and non-compliance to documentation retention requirements; 6) inadequate capacity management based on rapid business expansions and changes in business environments; 7) inadequate capacity management based on rapid business expansions and changes in business environments; 8) poor customer experience and increasing level of customer complaints; 9) lack of adherence to proper access controls and unauthorized use of data due to insufficient system capabilities; 10) lack of timeliness, accuracy and execution of new and existing customer communications; 11) ineffective and unstable systems (and application) infrastructure; 12) complex information technology with both application and infrastructure environment; 13) inadequate data quality; 14) enhanced regulatory scrutiny and rapid change in regulatory environment; 15) ineffective supplier risk management; and; 16) internal vulnerabilities combined with sophisticated and persistent external cyber attacks. Each of these risks 1030 is categorized into a separate organizational function 1010 of people 1012, processes 1014, systems 1016, and external events 1018. Each of the organizational functions 1010 may then be broken down into further sub-categories in the “Event Type” column 1020.

As illustrated in FIG. 10, the key operational risk 1030 of “extreme work load exposures” may be categorized within the “People” organizational function category 1010 and “Employment Practices and Workplace Safety” event type 1020. The “extreme work load exposures” operational risk may be further defined as consistently high workload exposure due to inadequate staff which may be due to staffing pauses and headcount reductions, resulting in detrimental impact to quality timeliness, excessive usage of contractors, and could increase overall turnover. Some example organizational/enterprise level key risk indicators 1040 associated with “extreme work load exposures” may include: 1) REO inventory greater than 180 days; and 2) Foreclosure speed (% within standard). The “extreme work load exposures” risk may be predictive (P) 1050.

As further illustrated in FIG. 10, the key operational risk 1030 of “key associate attrition” may be categorized within the “People” organizational function category 1010 and “Employment Practices and Workplace Safety” event type 1020. The “key associate attrition” operational risk may be further defined as key associate attrition combined with an inability to find, attract, and retain, key talent. Some example organizational/enterprise level key risk indicators 1040 associated with “key associate attrition” may include: 1) top talent retention or turnover or % full-time-employment gain or loss; 2) core FA turnover; and 3) trust turnover. The “key associate attrition” risk may be both predictive (P) and/or enterprise/organizational (E) 1050.

The key operational risk 1030 of “unauthorized usage of sensitive data and associate fraudulent activity” may be categorized within the “People” organizational function category 1010 and “Internal Fraud” event type 1020. The “unauthorized usage of sensitive data and associate fraudulent activity” operational risk may be further defined as unauthorized use (disclosure/manipulation) of data and associate fraudulent activities due to insufficient system capabilities or vulnerabilities, resulting in fraud, privacy breaches, legal actions, reputational impacts, and/or potential regulatory fines. Some example organizational/enterprise level key risk indicators 1040 associated with “unauthorized usage of sensitive data and associate fraudulent activity” may include: 1) critical application vulnerabilities past due; 2) outstanding confirms greater than 30 days; 3) unverified highly subjective valuations; and 4) failure to notify the control room. The “unauthorized usage of sensitive data and associate fraudulent activity” risk may be both predictive (P) and/or enterprise/organizational (E) 1050.

As further illustrated in FIG. 10, the key operational risk 1030 of “failure to meet strategic business objectives due to regulatory changes and compliance breaches” may be categorized within the “Process” organizational function category 1010 and both the “Client Products and Business Practices” and “Execution, Delivery, and Process Management” event types 1020. The “failure to meet strategic business objectives due to regulatory changes and compliance breaches” operational risk may be further defined as those failures resulting in failed process execution. Some example organizational/enterprise level key risk indicators 1040 associated with “failure to meet strategic business objectives due to regulatory changes and compliance breaches” may include: 1) earnings variability; 2) percentage of customers with complete CIP information; and 3) customers on-boarded with complete CIP information. The “failure to meet strategic business objectives due to regulatory changes and compliance breaches” risk may be enterprise/organizational (E) 1050.

As further illustrated in FIG. 10, the key operational risk 1030 of “inclination towards manual workaround than automation” may be categorized within the “Process” organizational function category 1010 and both the “Client Products and Business Practices” and “Execution, Delivery, and Process Management” event types 1020. The “inclination towards manual workaround than automation” operational risk may be further defined as inadequate process capacity to adjust to rapidly changing environment and a constantly morphing operating model. Some example organizational/enterprise level key risk indicators 1040 associated with “inclination towards manual workaround than automation” may include: 1) manufacturing quality; 2) REO inventory greater than 180 days; and 3) foreclosure speed (percent within standard). The “inclination towards manual workaround than automation” risk may be predictive (P) 1050.

As further illustrated in FIG. 10, the key operational risk 1030 of “inadequate or ineffective documentation issues and non-compliance to documentation retention requirements” may be categorized within the “Process” organizational function category 1010 and both the “Client Products and Business Practices” and “Execution, Delivery, and Process Management” event types 1020. One example organizational/enterprise level key risk indicator 1040 associated with “inadequate or ineffective documentation issues and non-compliance to documentation retention requirements” may include manufacturing quality. The “inadequate or ineffective documentation issues and non-compliance to documentation retention requirements” risk may be predictive (P) 1050.

As further illustrated in FIG. 10, the key operational risk 1030 of “inadequate capacity management based on rapid business expansions and changes in business environments” may be categorized within the “Process” organizational function category 1010 and both the “Client Products and Business Practices” and “Execution, Delivery, and Process Management” event types 1020. Some example organizational/enterprise level key risk indicators 1040 associated with “inadequate capacity management based on rapid business expansions and changes in business environments” may include: 1) manufacturing quality; 2) REO inventory greater than 180 days; and 3) foreclosure speed (percent within standard). The “inadequate capacity management based on rapid business expansions and changes in business environments” risk may be predictive (P) 1050.

As further illustrated in FIG. 10, the key operational risk 1030 of “poor customer experience and increasing level of customer complaints” may be categorized within the “Process” organizational function category 1010 and both the “Client Products and Business Practices” and “Execution, Delivery, and Process Management” event types 1020. Some example organizational/enterprise level key risk indicators 1040 associated with “poor customer experience and increasing level of customer complaints” may include: 1) executive complaints; and 2) manufacturing quality. The “poor customer experience and increasing level of customer complaints” risk may be both predictive (P) and enterprise/organizational (E) 1050.

As further illustrated in FIG. 10, the key operational risk 1030 of “lack of adherence to proper access controls and unauthorized use of data due to insufficient system capabilities” may be categorized within the “Process” organizational function category 1010 and both the “Client Products and Business Practices” and “Execution, Delivery, and Process Management” event types 1020. Some example organizational/enterprise level key risk indicators 1040 associated with “lack of adherence to proper access controls and unauthorized use of data due to insufficient system capabilities” may include: 1) critical application vulnerabilities past due; and 2) ID theft rate. The “lack of adherence to proper access controls and unauthorized use of data due to insufficient system capabilities” risk may be both predictive (P) and enterprise/organization (E) 1050.

As further illustrated in FIG. 10, the key operational risk 1030 of “lack of timeliness, accuracy and execution of new and existing customer communications” may be categorized within the “Process” organizational function category 1010 and both the “Client Products and Business Practices” and “Execution, Delivery, and Process Management” event types 1020. The “lack of timeliness, accuracy and execution of new and existing customer communications” operational risk may be further defined as negatively impacting customer experience leading to potential reputational risk. Some example organizational/enterprise level key risk indicators 1040 associated with “lack of timeliness, accuracy and execution of new and existing customer communications” may include: 1) executive complaints; and 2) manufacturing quality. The “lack of timeliness, accuracy and execution of new and existing customer communications” risk may be both predictive (P) and enterprise/organizational (E) 1050.

As further illustrated in FIG. 10, the key operational risk 1030 of “ineffective and unstable systems (and application) infrastructure” may be categorized within the “Systems” organizational function category 1010 and the “Business Disruption and Systems Failures” event type 1020. The “ineffective and unstable systems (and application) infrastructure” operational risk may be further defined as resulting in impacts on performance, scalability, reliability, security, work-around processes, dependencies on upstream/downstream. Some example organizational/enterprise level key risk indicators 1040 associated with “ineffective and unstable systems (and application) infrastructure” may include: 1) critical application recoverability; 2) tier-1 NP technology; 3) severity 1 and 2 incidents; 4) FCI frequency; and 5) FCI intensity. The “ineffective and unstable systems (and application) infrastructure” risk may be both predictive (P) and enterprise/organizational (E) 1050.

As further illustrated in FIG. 10, the key operational risk 1030 of “complex information technology (application and infrastructure) environment” may be categorized within the “Systems” organizational function category 1010 and the “Business Disruption and Systems Failures” event type 1020. The “complex information technology (application and infrastructure) environment” operational risk may be further defined as an environment with increased interaction complexity and a multitude of product/service offerings that may limit the ability to respond to the rapid pace of change from business/market/regulatory requirements and requires complex integrated releases/upgrades. An example organizational/enterprise level key risk indicators 1040 associated with “complex information technology (application and infrastructure) environment” may include critical application recoverability. The “complex information technology (application and infrastructure) environment” risk may be enterprise/organizational (E) 1050.

As further illustrated in FIG. 10, the key operational risk 1030 of “inadequate data quality” may be categorized within the “Systems” organizational function category 1010 and the “Business Disruption and Systems Failures” event type 1020. The “inadequate data quality” operational risk may be further defined as data inaccuracy, integrity, and timeliness that impacts reporting and decision-making, reputational risk, and financial loss. The key operational risk of “inadequate data quality” may not have any enterprise/organizational level key risk indicators 1040 identified. In this situation, a gap may exist where there is no key risk indicator coverage.

As further illustrated in FIG. 10, the key operational risk 1030 of “enhanced regulatory scrutiny and rapid change in regulatory environment” may be categorized within the “External Events” organizational function category 1010 and both the “Execution, Delivery, and Process Management” and “Damage to Physical Assets” event types 1020. The “enhanced regulatory scrutiny and rapid change in regulatory environment” operational risk may be further defined as increasing the risk of meeting strategic objectives, reputational risk, potential loss of customers and financial goals, rapid changes to business processes, and information technology applications. An example organizational/enterprise level key risk indicators 1040 associated with “enhanced regulatory scrutiny and rapid change in regulatory environment” may include external regulatory issues. The “enhanced regulatory scrutiny and rapid change in regulatory environment” risk may be enterprise/organizational (E) 1050.

As further illustrated in FIG. 10, the key operational risk 1030 of “ineffective supplier risk management” may be categorized within the “External Events” organizational function category 1010 and the “Execution, Delivery and Process Management” event type 1020. The “ineffective supplier risk management” operational risk may be further defined as including breach of contractual agreements, third party service reliability, and data management resulting in potential legal actions, customer dissatisfaction, contractual risks. An example organizational/enterprise level key risk indicators 1040 associated with “ineffective supplier risk management” may include composite supplier risk index. The “ineffective supplier risk management” risk may be enterprise/organizational (E) 1050.

As further illustrated in FIG. 10, the key operational risk 1030 of “internal vulnerabilities combined with sophisticated and persistent external cyber attacks” may be categorized within the “External Events” organizational function category 1010 and the “External Fraud” event type 1020. The “internal vulnerabilities combined with sophisticated and persistent external cyber attacks” operational risk may be further defined as impacting business disruption, monetary damage, and reputational damage. Some example organizational/enterprise level key risk indicators 1040 associated with “internal vulnerabilities combined with sophisticated and persistent external cyber attacks” may include: 1) critical application vulnerabilities past due; 2) ID theft rate; 3) blended false positive rate; 4) percent of newly opened accounts closed on day-2; 5) check fraud—volume by claim; and 6) account detected rate. The “internal vulnerabilities combined with sophisticated and persistent external cyber attacks” risk may be both predictive (P) and enterprise/organizational (E) 1050.

As further illustrated in FIG. 3, at block 314, the seventh and final step may be an ongoing monitoring of KRI performance. This ongoing monitoring step 314 may be accomplished through back-testing, continuous adjustment, and dynamic calibration. The ongoing monitoring of KRI performance step may include on an annual basis validation, for example—other time period may be utilized without departing from this invention. The validation may include validating the relevance of the top risks identified. The validation may also include validating the need for new and/or additional monitoring metrics. The validation may also include validating the performance of the KRIs when compared to losses. Additionally, the KRI back-testing may include back-testing the KRIs against future losses to derive a point of view on the KRI performance and relevance against losses.

The ongoing monitoring step 314 may also include sustainability, which may include repeating the fourth step 308 of the quantitative/statistical analysis. Repeating the quantitative/statistical analysis step 308 may derive statistical associations for metrics for losses. The sustainability may ensure relevance and performance of the key risk indicators identified by the firm or organization at any given snapshot in time. The sustainability may also ensure that the set of key risks are relevant to the firm or organization and that the key risk indicators represent the best set of monitoring metrics that are relevant to the risks being monitored. The burden of the sustainability may be minimum since the regression models may be reused.

Additional embodiments of this invention may include a broader and bigger market beyond the domestic United States. Basel II compliance may be phased with Europe and other North American early pioneers, compared to other regions/countries. The aspects and embodiments of this invention may be utilized within the United States and outside of the United States. Even though regional central banks and organizations may extend the Basel II framework for regulatory compliance and guidelines, by and large, many other countries follow the guidelines set for in the United States. Many firms and organizations (even non-banking and non-financial sector) report risk indicators to senior management. The concept of the use of a risk indicators is industry agnostic, so many other industries and organizations may utilize the key risk indicator identification process as described without departing from this invention.

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments. They may determine that the requirements should be applied to third party service providers (e.g., those that maintain records on behalf of the company).

We claim:

1. A computer-assisted method comprising:
identifying a set of key risks using a first triangulation process with risk information for an identified risk;
identifying a set of potential risk indicators associated with the identified risks using a second triangulation process;
conducting, by a risk management computer system, quantitative and statistical analysis to identify a set of statistical associations and a set of predictive relationships of the potential risk indicators and the key risks through correlation testing and regression modeling; and
selecting a set of predictive key risk indicators from the set of statistical associations and the set of predictive relationships.

2. The method of claim 1, further comprising:
setting thresholds for the set of predictive key risk indicators; and
verifying coverage for the set of predictive key risk indicators.

3. The method of claim 2, further comprising:
reporting potential gaps in coverage for the set of predictive key risk indicators.

4. The method of claim 1, further comprising:
pre-processing risk data to perform the quantitative and statistical analysis.

5. The method of claim 4, wherein the pre-processing risk data step includes:
processing, by the risk management computer system, of risk data by building metric risk data sets;
performing, by the risk management computer system, data analysis of the metric risk data sets; and
profiling, by the risk management computer system, the metric risk data sets to enable the quantitative and statistical analysis.

6. The method of claim 4, wherein the pre-preprocessing of risk data step includes a Box-Cox power transformation or a set of time-series plots.

7. The method of claim 1, wherein the first triangulation process includes risk information for the identified risk that includes: historical losses, emerging risks, and qualitative judgment.

8. The method of claim 1, wherein a historical loss heat map is utilized to identify historical losses.

9. The method of claim 1, wherein the second triangulation process includes: obtaining monitoring metrics for each of the identified risks, using qualitative judgment to validate and narrow down the monitoring metrics and validate and narrow down the risk indicators, and performing selective causal analysis and hypothesis testing.

10. The method of claim 1, wherein the regression modeling includes metric association with loss frequency and metric association with loss severity.

11. The method of claim 1, wherein during the selecting a set of predictive key risk indicators step, a prioritization scheme is applied that includes the following four components: quantitative aspects, qualitative feedback, exposure to multiple business units, and historical loss exposure.

12. The method of claim 1, further comprising the step of:
monitoring the set of key risk indicators for performance.

13. An apparatus comprising:
at least one memory; and
at least one processor coupled to the at least one memory and configured to perform, based on instructions stored in the at least one memory:
identifying a set of key risks using a first triangulation process with risk information for an identified risk;
identifying risk indicators associated with the identified risks using a second triangulation process;
pre-processing risk data to perform the quantitative and statistical analysis;
conducting, by a risk management computer system, quantitative and statistical analysis to identify a set of statistical associations and a set of predictive relationships of the risk indicators and the key risks through correlation testing and regression modeling;
selecting a set of predictive key risk indicators from the set of statistical associations and the set of predictive relationships;
setting thresholds for the set of predictive key risk indicators; and
verifying coverage for the set of predictive key risk indicators.

14. The apparatus of claim 13, wherein the at least one processor is further configured to perform:
reporting potential gaps in coverage for the set of predictive key risk indicators.

15. The apparatus of claim 13, wherein the pre-processing risk data instruction includes:
processing, by the risk management computer system, of risk data by building metric risk data sets;
performing, by the risk management computer system, data analysis of the metric risk data sets; and
profiling, by the risk management computer system, the metric risk data sets to enable the quantitative and statistical analysis.

16. The apparatus of claim 15, wherein the pre-preprocessing of risk data instruction includes a Box-Cox power transformation or a set of time-series plots.

17. The apparatus of claim 13, wherein the first triangulation process includes risk information for the identified risk that includes: historical losses, emerging risks, and qualitative judgment, and further wherein the historical losses are identified by a historical loss heat map.

18. The apparatus of claim 13, wherein the second triangulation process includes: obtaining monitoring metrics for each of the identified risks, using qualitative judgment to validate and narrow down the monitoring metrics and validate and narrow down the risk indicators, and performing selective causal analysis and hypothesis testing.

19. A computer-readable storage medium storing computer-executable instructions that, when executed, cause a processor to perform a method comprising:
identifying a set of key risks using a first triangulation process with risk information for an identified risk, wherein the first triangulation process includes risk information for the identified risk that includes: historical losses, emerging risks, and qualitative judgment, and further wherein the historical losses are identified by a historical loss heat map;
identifying risk indicators associated with the identified risks using a second triangulation process, wherein the second triangulation process includes: obtaining monitoring metrics for each of the identified risks, using qualitative judgment to validate and narrow down the monitoring metrics and validate and narrow down the risk indicators, and performing selective causal analysis and hypothesis testing;
conducting, by a risk management computer system, quantitative and statistical analysis to identify a set of statistical associations and a set of predictive relationships of the risk indicators and the key risks through correlation testing and regression modeling; and
selecting a set of predictive key risk indicators from the set of statistical associations and the set of predictive relationships.

20. The computer-readable medium of claim 19, said method further comprising:
setting thresholds for the set of predictive key risk indicators;
verifying coverage for the set of predictive key risk indicators; and.
reporting potential gaps in coverage for the set of predictive key risk indicators.

21. The computer-readable medium of claim 19, said method further comprising:
pre-processing risk data to perform the quantitative and statistical analysis.

22. The computer-readable medium of claim 21, wherein the pre-processing risk data instruction includes:
processing, by the risk management computer system, of risk data by building metric risk data sets;
performing, by the risk management computer system, data analysis of the metric risk data sets; and
profiling, by the risk management computer system, the metric risk data sets to enable the quantitative and statistical analysis.

23. The computer-readable medium of claim 19, said method further comprising:
monitoring the set of key risk indicators for performance.

24. The computer-readable medium of claim 19, wherein the regression modeling includes metric association with loss frequency and metric association with loss severity.

25. The computer-readable medium of claim 19, wherein during the selecting a set of predictive key risk indicators instruction, a prioritization scheme is applied that includes the following four components: quantitative aspects, qualitative feedback, exposure to multiple business units, and historical loss exposure.
